(19) United States
(12) Patent Application Publication
(10) Pub. No.: US 2003/0038459 A1
(43) Pub. Date: Feb. 27, 2003

(54) Gas generator for an airbag on the steering wheel of a motor vehicle

(76) Inventors: Markus Leibach, Schweighof (DE); Friedrich Back, Mullheim (DE); Markus Durre, Sulzberg (DE); Thilo Berg, Gimbsheim (DE)

Correspondence Address: KENYON & KENYON, ONE BROADWAY, NEW YORK, NY, 10004, US

(21) Appl. No.: 10/091,831

(22) Filed: Mar. 5, 2002

(30) Foreign Application Priority Data
Mar. 5, 2001 (DE) 101 10 534.7

(51) Int. Cl. B60R 21/16

(52) U.S. Cl. 280/728.2

(57) ABSTRACT

A gas generator for an airbag on the steering wheel of a motor vehicle has a container for holding a propellant charge, the gas generator being designed as a vibration-reducing element, and the container being connected to the steering wheel by a mounting flange and a gas-impermeable spring element made of a polymer material in the shape of a hollow truncated cone, the connection between the spring element (1) and the container (3) and/or the mounting flange (2) being designed as a clamping connection (4, 5).

### BACKGROUND OF THE INVENTION

1. Field of the Invention

The invention relates to a gas generator for an airbag on the steering wheel of a motor vehicle having a container for holding a propellant charge, the gas generator being designed as a vibration-reducing element, and the container being connected to the steering wheel by a mounting flange and a gas-impermeable spring element made of a polymer material in the shape of a hollow truncated cone.

2. Description of Related Art

The vibration occurring in motor vehicles when the engine is running while driving or at a standstill may be transmitted to the steering column and from there to the steering wheel. To counteract this vibration on the steering wheel and to improve driving comfort, vibration-reducing elements using the gas generator as an oscillating weight have become known.

German Utility Model 299 02 033 U1 describes an airbag module which uses a mounting cylinder made of an elastic material, its free edges being connected on the one hand to a ring-shaped mounting plate situated on the gas generator carrier and on the other hand to a peripheral mounting flange connected to the housing of the gas generator. This forms a good seal for the gases exiting the gas generator and yields a justifiable vibration behavior. However, the connection between the mounting cylinder and the mounting plate or mounting flange is not satisfactory. It is impossible to reliably prevent damage to the joints with this design. Another disadvantage is that retrofitting is impossible. Therefore, an improved possibility of connection between the container of the gas generator and the mounting flange was proposed in the older German Patent 100 586 251. In addition, the spring element was designed as a hollow, truncated conical spring element which has an improved vibration behavior because of its shape.

### SUMMARY OF THE INVENTION

It is an object of the invention to provide a gas generator for an airbag having a reliable, simple-to-manufacture connection between the spring element and the container or mounting flange so that the function of the gas generator should not be impaired.

These and other objects of the invention are achieved by a gas generator wherein the connection between the spring element and the container and/or the mounting flange is designed as a clamping connection. Not only does this connection ensure that it is impossible for the spring element and the connection parts to become separated, but it also offers the possibility of a gas generator which is easy to install in the airbag.

### BRIEF DESCRIPTION OF THE DRAWINGS

The present invention will be described in greater detail with reference to the following drawings wherein:

FIG. 1 shows a partial section of a container having a spring element and a mounting flange in a side view.

FIG. 2 shows an enlarged detail x from FIG. 1.

FIG. 3 shows a container partially in side view and in a sectional view with another type of mounting.

FIG. 4 shows an enlarged detail x from FIG. 3.

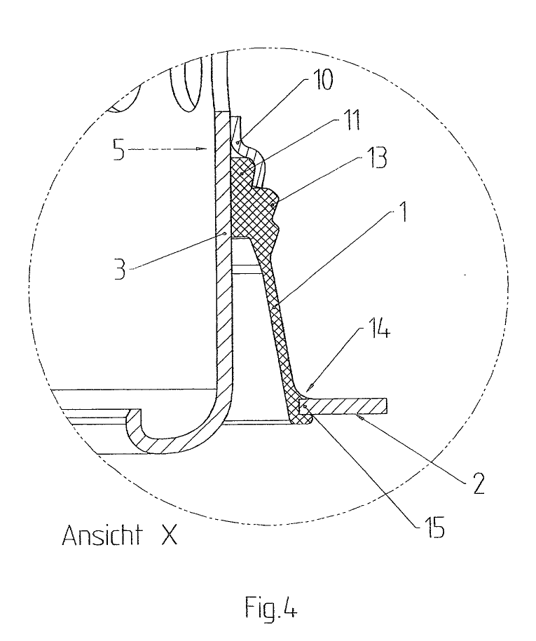

### DETAILED DESCRIPTION OF THE INVENTION T

he clamping connections may have various designs. One favorable option is for the filter tube to be provided with a ring-shaped clamping flange beneath the gas outlet openings provided in its wall, so that the lower edge of the flange engages in the upper edge of the spring element and presses it against the container. This establishes a very secure and tight connection between the spring element and the container. The clamping flange may be placed on the container in a form-fitting manner. Welding or the like is also possible without any great expenditure.

It is advantageous if the upper edge of the spring element is designed as a clamping bead. To prevent the clamping flange from striking against the generator cover in the event of a higher amplitude of vibration, the spring element is provided with stop projections beneath the clamping bead, preferably in the form of a ring bead projecting radially beyond the clamping flange.

The connection between the spring element and the mounting flange may also be adapted to the given conditions. However, it is especially advantageous if the mounting flange is designed in two parts and the lower edge of the spring element is clamped between the two parts of the mounting flange. This may be accomplished, for example, during the assembly of the gas generator in the airbag housing. To reinforce the mounting, the lower edge of the spring element may be provided with a clamping bead which projects radially outward.

In especially simple embodiments, the connection between the spring element and the mounting flange may also be established by vulcanization.

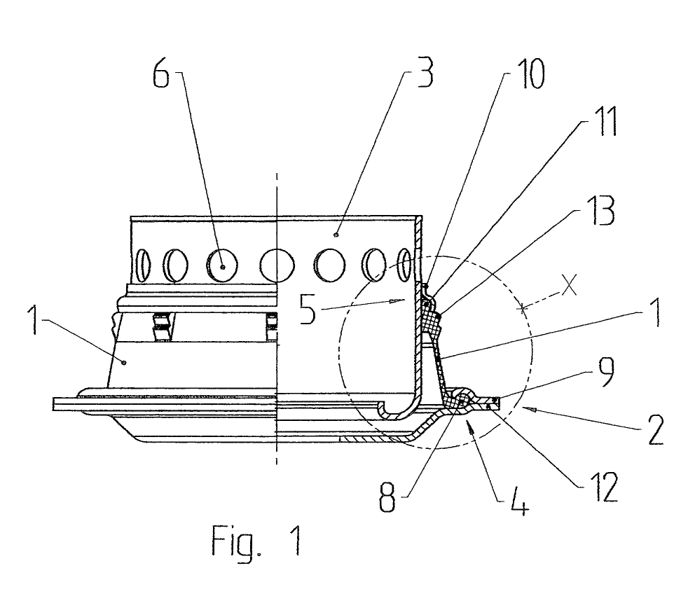

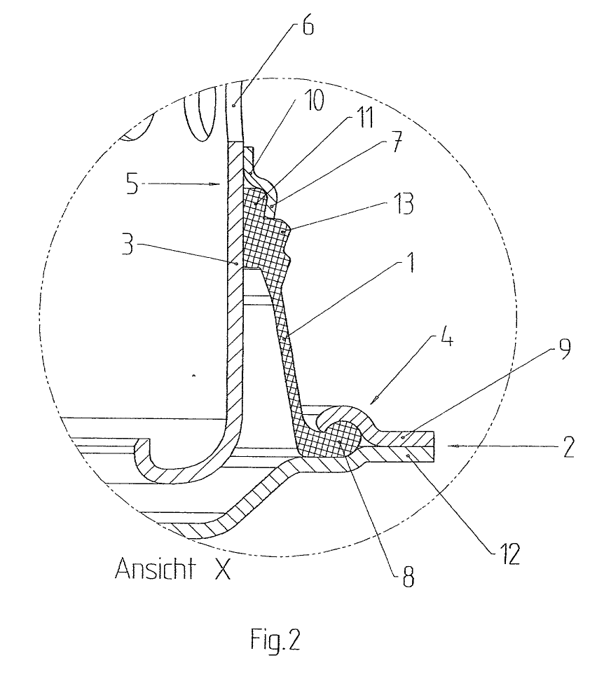

In FIG. 1, spring element 1 is joined to mounting flange 2 and container 3 by clamping connections 4 and 5. The gas generator (not shown) is inserted into container 3. On the left side of FIG. 1, spring element 1 having mounting flange 2 and container 3 is shown in a side view. The right side of the figure represents a section through these parts. FIG. 2 shows an enlarged detail x. Ring-shaped clamping flange 10 is provided beneath gas through-opening 6 in the wall of container 3. With its lower edge 7, this clamping flange 10 grips upper edge 11 of spring element 1. Edge 11 is pressed against container 3 by flanging lower edge 7 of clamping flange 10. To secure it well, upper edge 11 of the spring element is designed as a peripheral clamping bead. Beneath this clamping bead, spring element 1 is provided with stop projections 13. These projections 13 are composed of a ring bead projecting radially outward beyond clamping flange 10. This ring bead 13 may optionally be interrupted, so that stop projections 13 are distributed uniformly around the periphery of spring element 1. Clamping connection 4 to mounting flange 2 is achieved by a twopart design of mounting flange 2. The lower edge of spring element 1 is provided with a clamping bead 8 which projects radially outward and is clamped between two parts 9 and 12 of mounting flange 2. Spring element 1, container 3 and mounting flange 2 may be preassembled as a unit and then inserted into the airbag module.

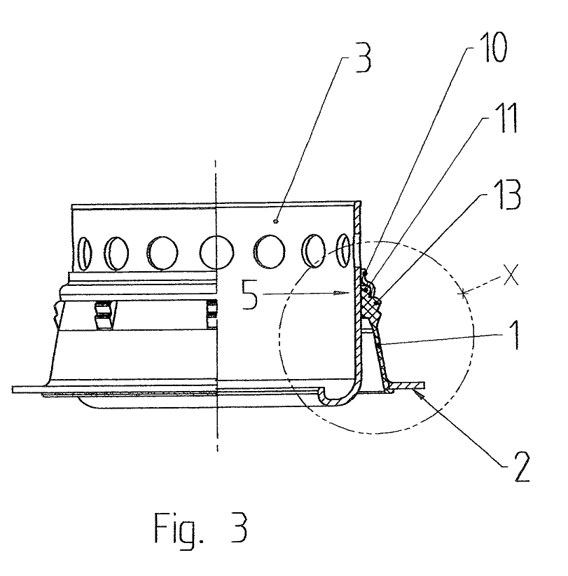

FIG. 3 shows an embodiment in which clamping connection 5 between spring element 1 and container 3 is designed in the same way as in FIGS. 1 and 2. However, the connection between spring element 1 and mounting flange 2 is established by vulcanization. Such an option is advantageous if little space is available beneath mounting flange 2. For mounting spring element 1 on mounting flange 2, spring element 1 is provided on its lower edge with a groove 14 which borders inside edge 15 of mounting flange 2.

What is claimed is:

1. A gas generator for an airbag on the steering wheel of a motor vehicle, comprising: a container for holding a propellant charge, the gas generator being designed as a vibration-reducing element, and the container being connected to the steering wheel by a mounting flange and a gas-impermeable spring element made of a polymer material in the shape of a hollow truncated cone, wherein the connection between the spring element (1) and the container (3) or the mounting flange (2) is designed as a clamping connection (4, 5).

2. The gas generator according to claim 1, wherein beneath gas through-openings (6) in the wall of the container, the container (3) is provided with a ring-shaped flange (10) which with its lower edge (7) engages by flanging over in the upper edge (11) of the spring element (1) and presses it against the container (3).

3. The gas generator according to claim 1, wherein the upper edge (11) of the spring element (1) is designed as a clamping bead.

4. The gas generator according to claim 2, wherein the upper edge (11) of the spring element (1) is designed as a clamping bead.

5. The gas generator according to claim 1, wherein beneath the clamping bead, the spring element (1) is provided with stop projections (13).

6. The gas generator according to claim 2, wherein beneath the clamping bead, the spring element (1) is provided with stop projections (13).

7. The gas generator according to claim 3, wherein beneath the clamping bead, the spring element (1) is provided with stop projections (13).

8. The gas generator according to claim 5, wherein the stop projections are the form of a ring bead, projecting radially beyond the clamping flange (10).

9. The gas generator according to claim 1, wherein the mounting flange (2) is designed in two parts, and the lower edge of the spring element (1) is clamped between the two parts (9, 12) of the mounting flange (2).

10. The gas generator according to claim 2, wherein the mounting flange (2) is designed in two parts, and the lower edge of the spring element (1) is clamped between the two parts (9, 12) of the mounting flange (2).

11. The gas generator according to claim 3, wherein the mounting flange (2) is designed in two parts, and the lower edge of the spring element (1) is clamped between the two parts (9, 12) of the mounting flange (2).

12. The gas generator according to claim 5, wherein the mounting flange (2) is designed in two parts, and the lower edge of the spring element (1) is clamped between the two parts (9, 12) of the mounting flange (2).

13. The gas generator according to claim 9, wherein the lower edge of the spring element (1) is provided with a clamping bead (8).

14. The gas generator according to claim 13, wherein the clamping bead (8) projects radially outward.

15. The gas generator according to claim 1, wherein the connection between the spring element (1) and the mounting flange (2) is established by vulcanization.

16. The gas generator according to claim 2, wherein the connection between the spring element (1) and the mounting flange (2) is established by vulcanization.

17. The gas generator according to claim 3, wherein the connection between the spring element (1) and the mounting flange (2) is established by vulcanization.

18. The gas generator according to claim 15, wherein the spring element (1) is provided on its lower edge with a groove (14) which encloses the inside edge (15) of the mounting flange (2).
